(19) United States
(12) Patent Application Publication
(10) Pub. No.: US 2014/0149193 A1
(43) Pub. Date: May 29, 2014

(54) MANAGING A RETAIL OFFER

(71) Applicant: INTERNATIONAL BUSINESS MACHINES CORPORATION, Armonk, NY (US)

(72) Inventors: Lisa Seacat DeLuca, San Francisco, CA (US); Lydia M. Do, Raleigh, NC (US); Jenny S. Li, Danbury, CT (US)

(73) Assignee: International Business Machines Corporation, Armonk, NY (US)

(21) Appl. No.: 13/686,602

(22) Filed: Nov. 27, 2012

(51) Int. Cl. G06Q 30/02

(52) U.S. Cl. CPC G06Q 30/0252
USPC 705/14.5

(57) ABSTRACT

An approach for managing retail offer(s) based on information from a social networking website is presented. Information about an event is received. The event is determined to be relevant to user(s) of the social networking website by determining preferences of the user(s) and determining the user(s) have an interest in the event based on the preferences. Retail offers are received. Received retail offer(s) are determined to be relevant to the event by determining a preference of an individual associated with event and determining the individual has an interest in the retail offer(s) based on the preference. Based on the event being relevant to the user(s) and the retail offer(s) being relevant to the event, the retail offer(s) are displayed for viewing by the user(s) via an interface provided by the social networking website.

### TECHNICAL FIELD

The present invention relates to a data processing method and system for managing a retail offer, and more particularly to managing a retail offer based on an event and information provided by a social networking service.

### BACKGROUND

Merchants send many coupons to users via emails and/or text messages to promote discounts, rebates and other offers related to potential purchases of products and services. Each user manually manages the received coupons. Known online services may send a user alerts about coupons, but the user still manually manages the coupons. The Amazon® Gift Organizer allows a user to track upcoming events and which gifts have been purchased for the tracked events, and may provide suggestions about what gift to give based on a relationship type, price, and/or other attributes. Amazon® Gift Organizer is offered by Amazon.com, Inc. located in Seattle, Wash. A user's Facebook® social network account may be linked to the user's Amazon® e-commerce account, which allows the user to view recommendations provided by the Amazon® account based on the user's interests and activity provided by the Facebook® account. The Facebook® social network is offered by Facebook, Inc., located in Menlo Park, Calif. The linkage between the user's Amazon® and Facebook® accounts may also allow a determination of types of gifts appropriate for the user's friends listed in the user's Facebook®account by (1) searching Amazon® Wish Lists of the friends, or (2) pulling information from Facebook® profiles of the friends.

### BRIEF SUMMARY

In first embodiments, the present invention provides a method of managing one or more retail offers. The method includes a computer receiving information about an event. The method further includes the computer determining the event is relevant to one or more users of a social network website by (1) determining preferences of the one or more users; and (2) determining the one or more users have an interest in the event based on the preferences. The preferences are saved via the social network website. The method further includes the computer receiving a plurality of retail offers. The method further includes the computer determining one or more retail offers included in the plurality of retail offers are relevant to the event by (1) determining at least one preference of an individual associated with the event; and (2) determining the individual has an interest in the one or more retail offers based on the at least one preference. The at least one preference is saved via the social network website. The method further includes, based on the event being relevant to the one or more users and based on the one or more retail offers being relevant to the event, the computer initiating a display of the one or more retail offers for viewing by the one or more users via an interface provided by the social network web site.

In second embodiments, the present invention provides a computer system including a central processing unit (CPU), a memory coupled to the CPU, and a computer-readable, tangible storage device coupled to the CPU. The storage device contains instructions that, when carried out by the CPU via the memory, implement a method of managing one or more retail offers. The method includes the computer system receiving information about an event. The method further includes the computer system determining the event is relevant to one or more users of a social network website by (1) determining preferences of the one or more users; and (2) determining the one or more users have an interest in the event based on the preferences. The preferences are saved via the social network website. The method further includes the computer system receiving a plurality of retail offers. The method further includes the computer system determining one or more retail offers included in the plurality of retail offers are relevant to the event by (1) determining at least one preference of an individual associated with the event; and (2) determining the individual has an interest in the one or more retail offers based on the at least one preference. The at least one preference is saved via the social network website. The method further includes, based on the event being relevant to the one or more users and based on the one or more retail offers being relevant to the event, the computer system initiating a display of the one or more retail offers for viewing by the one or more users via an interface provided by the social network website.

In third embodiments, the present invention provides a computer program product including a computer-readable, tangible storage device and computer-readable program instructions stored in the computer-readable, tangible storage device. The computer-readable program instructions, when carried out by a central processing unit (CPU) of a computer system, implement a method of managing one or more retail offers. The method includes the computer system receiving information about an event. The method further includes the computer system determining the event is relevant to one or more users of a social network website by (1) determining preferences of the one or more users; and (2) determining the one or more users have an interest in the event based on the preferences. The preferences are saved via the social network website. The method further includes the computer system receiving a plurality of retail offers. The method further includes the computer system determining one or more retail offers included in the plurality of retail offers are relevant to the event by (1) determining at least one preference of an individual associated with the event; and (2) determining the individual has an interest in the one or more retail offers based on the at least one preference. The at least one preference is saved via the social network website. The method further includes, based on the event being relevant to the one or more users and based on the one or more retail offers being relevant to the event, the computer system initiating a display of the one or more retail offers for viewing by the one or more users via an interface provided by the social network website.

In fourth embodiments, the present invention provides a process for supporting computing infrastructure. The process includes a first computer system providing at least one support service for at least one of creating, integrating, hosting, maintaining, and deploying computer-readable code in a computer system including a processor. The processor carries out instructions contained in the code causing the computer system to perform a method of managing one or more retail offers. The method includes the computer system receiving information about an event. The method further includes the computer system determining the event is relevant to one or more users of a social network website by (1) determining preferences of the one or more users; and (2) determining the one or more users have an interest in the event based on the preferences. The preferences are saved via the social network website. The method further includes the computer system receiving a plurality of retail offers. The method further includes the computer system determining one or more retail offers included in the plurality of retail offers are relevant to the event by (1) determining at least one preference of an individual associated with the event; and (2) determining the individual has an interest in the one or more retail offers based on the at least one preference. The at least one preference is saved via the social network website. The method further includes, based on the event being relevant to the one or more users and based on the one or more retail offers being relevant to the event, the computer system initiating a display of the one or more retail offers for viewing by the one or more users via an interface provided by the social network web site.

Embodiments of the present invention leverage aspects of a social networking service to determine, manage, and display retail offers relevant to an event, where the event is relevant to users of the social networking service. A user of the social networking service who has an interest in the event may use the social networking service to view information about the event, update preference(s) of the user, and view a dynamically updated list of retail offers that are relevant to the event. The dynamically updated list may indicate which retail offers have been redeemed and which retail offers have not been redeemed.

### BRIEF DESCRIPTION OF THE DRAWINGS

FIG. 1 depicts a block diagram of a system for managing one or more retail offers, in accordance with embodiments of the present invention.

FIG. 2 is a flowchart of a process of managing one or more retail offers, where the process is implemented in the system of FIG. 1, in accordance with embodiments of the present invention.

FIG. 3 is a flowchart of a process of managing one or more retail offers based on a relationship provided by a social networking service, where the process is implemented in the system of FIG. 1, in accordance with embodiments of the present invention.

FIG. 4 is a flowchart of a process of managing a display of retail offers based on a geographic proximity of a retailer to a user, where the process is implemented in the system of FIG. 1, in accordance with embodiments of the present invention.

FIG. 5 is a flowchart of a process of managing a display of retail offers based on categories of the retail offers, where the process is implemented in the system of FIG. 1, in accordance with embodiments of the present invention.

FIG. 6 is a flowchart of a process of managing a display of retail offers based on an attribute of the retail offers, where the process is implemented in the system of FIG. 1, in accordance with embodiments of the present invention.

FIG. 7 is a flowchart of a process of managing one or more retail offers based on a time period associated with an event, where the process is implemented in the system of FIG. 1, in accordance with embodiments of the present invention.

FIG. 8 is an exemplary view of an event page provided by a social networking service, where the event page includes information about an event and a dynamically updated list of retail offers managed by the process of FIG. 2, in accordance with embodiments of the present invention.

FIG. 9 is a block diagram of a computer system that is included in the system of FIG. 1 and that implements the processes of FIG. 2, FIG. 3, FIG. 4, FIG. 5, FIG. 6 and FIG. 7 in accordance with embodiments of the present invention.

### DETAILED DESCRIPTION

### Overview

Embodiments of the present invention utilize information from a social networking service to identify an event, identify users of the social networking service to whom the event is relevant, determine retail offers that are relevant to the event, and manage a display of the retail offers that may be viewed by the identified users via an interface provided by the social networking service. The display of retail offers may be dynamically updated to (1) indicate retail offers that are redeemed by any of the identified users, (2) present new retail offers that are determined to be relevant to the event, and/or (3) remove retail offers that are determined to be no longer relevant to the event.

With known techniques, the inflexibility and/or manual nature of retail offer management activities lead to deficiencies in sharing information in the retail offers and/or human error in maintaining the information, thereby posing unique challenges. At least one of these unique challenges is overcome by one or more embodiments of the present invention.

As used herein, a retail offer is defined as a document, certificate, ticket or code that can be redeemed or otherwise used to obtain a financial reward, discount or rebate for the purchase of a product or service from a retailer, and that is included in, attached to, linked to, or otherwise accessible from a website or from an email, text message or other digital message sent via a computer network to a user's computer, mobile device, or other computing device. Retail offers include, for example, internet coupons and discounted gift certificates provided by deal of the day websites such as the Groupon® website. Groupon is a registered trademark of Groupon, Inc. located in Chicago, Ill.

### System for Managing One or More Retail Offers

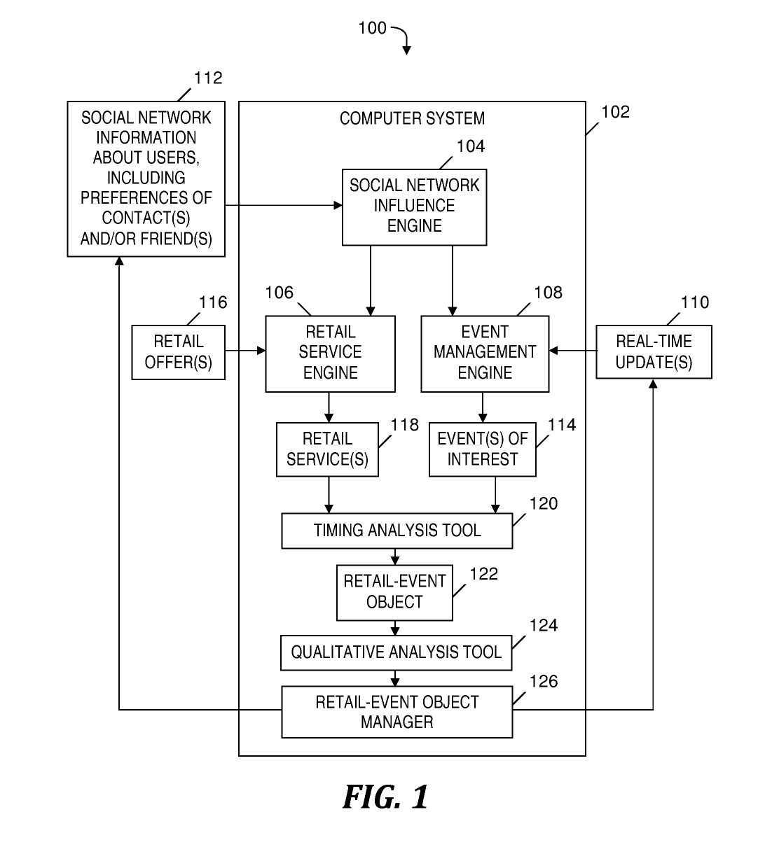

FIG. 1 depicts a block diagram of a system for managing one or more retail offers, in accordance with embodiments of the present invention. System 100 includes a computer system 102, which runs a software-based social network influence engine 104, a software-based retail service engine 106 and a software-based event management engine 108.

Event management engine 108 receives real-time updates 110 to information on a website. In one embodiment, real-time updates 110 may include updates to an activity stream, notifications, or other content managed by a social networking service. In another embodiment, real-time updates 110 may include updates to blog(s) and/or feed(s) provided by feed aggregator(s). Event management engine 108 identifies or determines events.

Social network influence engine 104 receives social network information 112 about users of the social networking service. Social network information 112 includes preferences of the users and contacts and/or friends of the users. Event management engine 108 receives social network information 112 from social network influence engine 104 to identify and manage event(s) 114 that are potentially of interest to user(s) of the social networking service.

Retail service engine 106 receives retail offer(s) 116 and social network information 112 from social network influence engine 104 to determine retail service(s) 118 that provide retail offer(s) included in retail offer(s) 116 that are relevant to an individual associated with at least one of event(s) 114.

A software-based timing analysis tool 120 receives information from retail service engine 106 about time period(s) (a.k.a. “retail offer redemption time period(s)”) during which the retail offer(s) offered by retail service(s) 118 are redeemable and receives other information from event management engine 108 about other time period(s) (a.k.a. “event purchase time period(s)”) during which user(s) of the social networking service are interested in purchasing retail item(s) (i.e., product(s) or service(s)) for event(s) 114. Timing analysis tool 120 compares the aforementioned time periods and generates a retail-event object 122 that specifies an event included in event(s) 114 and one or more retail offers provided by retail service(s) 118 that are redeemable during the event purchase time period corresponding to the event. Hereinafter, in the description of FIG. 1, the event specified by retail-event object 122 is referred to simply as “the event” and the one or more retail offers specified by retail-event object 122 are referred to simply as “the retail offer(s).”

A software-based qualitative analysis tool 124 performs a qualitative analysis to select, prioritize and/or categorize retail offers included in retail-event object 122 and other retail-event objects (not shown). Qualitative analysis tool 124 provides the result of the selection, prioritization and/or categorization of the retail offers to a software-based retail-event object manager 126. In one embodiment, qualitative analysis tool 124 determines whether the specification of any of the retail offer(s) included in retail-event object 122 matches one or more preferences of the individual associated with the event and/or one or more preferences of a user of the social networking website who is identified as potentially having an interest in the event, where the preference(s) had been selected to determine which retail offers are most relevant to the event. If qualitative analysis tool 124 determines a match between any of the retail offer(s) and the aforementioned preference(s), then qualitative analysis tool 124 provides retail-event object 122 to a retail-event object manager 126 together with an indication of which retail offer(s) match the aforementioned preference(s).

Retail-event object manager 126 generates a display in an interface of the social networking service, where the display includes the retail offers provided by qualitative analysis tool 124 as being relevant to the event, and where the display is presented on a display device coupled to computer system 102 or to another computing device (not shown). In one embodiment, retail-event object manager 126 generates a display that includes the retail offers provided by qualitative analysis tool 124 along with indications of who has redeemed one or more of the retail offers. In real-time, retail-event object manager 126 updates the indications of who has redeemed one or more of the retail offers.

As one example, the event is a birthday party for person P for which a group of users of the social networking service includes users who are invited to the birthday party and/or users who are otherwise identified as being potentially interested in the birthday party, where the group of users are planning to purchase one or more gifts for P. Computer system 102 receives an indication that only retail offers for an item of brand X, Y or Z will be selected from among all the retail offers received by retail service engine 106. Qualitative analysis tool 124 determines whether each received retail offer is for an item of brand X, Y or Z. If the retail offer is for an item of brand X, Y or Z, then qualitative analysis tool 124 provides the retail-event object that includes the retail offer to retail-event object manager 126. Retail-event object manager initiates a display of the retail offers for items of brands X, Y and Z.

Retail-event object manager 126 manages received retail-event object 122 by monitoring subsequent (1) real-time update(s) 110 to information associated with the event, and/or (2) updates to social network information 112. In one embodiment, retail-event object manager 126 provides real-time update(s) 110 to event management engine 108, where the update(s) may include, for example, a change to the date or time of the event. In one embodiment, retail-event object manager 126 provides updates of social network information 112 to social network influence engine 104, where the updates may include, for example, an update to a preference of an individual associated with the event and/or an update to a preference of a user of the social network service who is potentially interested in the event.

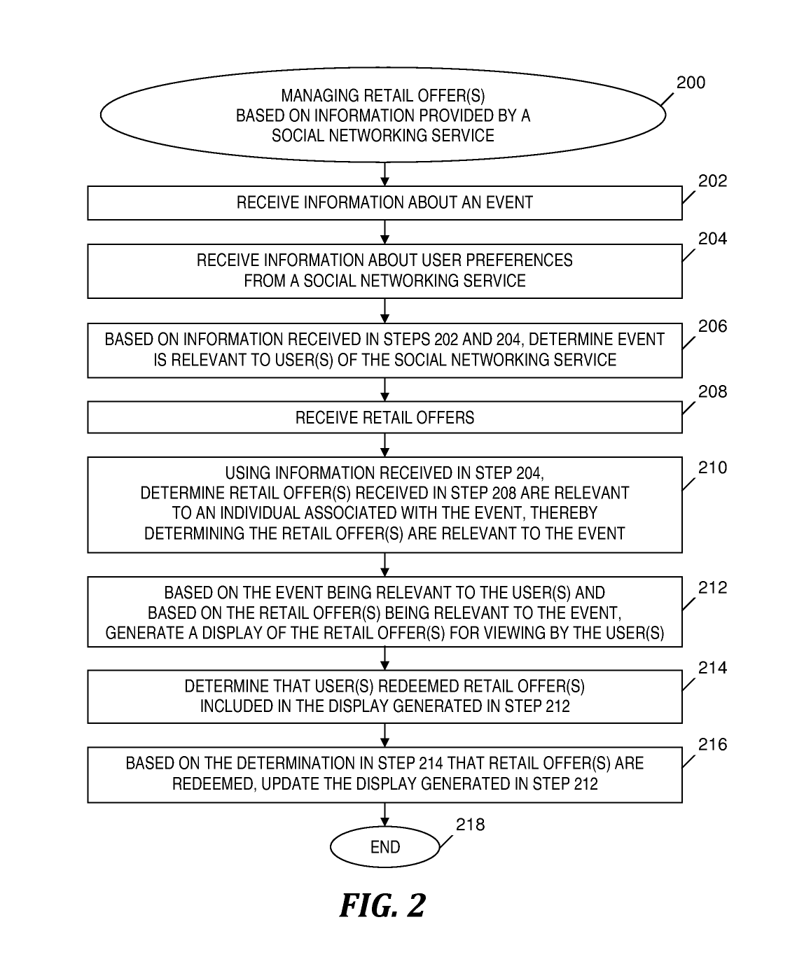

In one embodiment, computer system 102 is external to a system that provides the social networking service (e.g., computer system 102 resides on a user's computing device). In another embodiment, computer system 102 resides in the system that provides the social networking service. The functionality of the components shown in FIG. 1 is described in more detail in the discussions of FIGS. 2-6 and FIG. 8 presented below.

### Process for Managing One or More Retail Offers

FIG. 2 is a flowchart of a process of managing one or more retail offers, where the process is implemented in the system of FIG. 1, in accordance with embodiments of the present invention.

The process of managing retail offer(s) based on information provided by a social networking service begins at step 200. In step 202, event management engine 108 (see FIG. 1) receives information about an event. Event management engine 108 (see FIG. 1) may receive the information about the event from a user of the social networking service or as a result of performing a text, graphical, audio and/or video analysis of information in an event page in a social networking service, activity stream in a social networking service, feed managed by a feed aggregator, blog, podcast, video blog, etc. In one embodiment, the received information about the event includes an indication that the event participants may be interested in making one or more purchases of item(s) (i.e., product(s) and/or service(s)) from retailer(s), and that retail offer(s) for item(s) relevant to the event are to be collected by computer system 102 (see FIG. 1). The received information about the event may also specify when the event starts (i.e., a date or a date and time), and/or a time period during which the event occurs.

In step 204, social network influence engine 104 (see FIG. 1) receives information about preference(s) of user(s) of the social networking service and sends the received information to event management engine 108 (see FIG. 1). The preference(s) may be received in step 204 in the manner described above relative to the event information received in step 202.

In step 206, based on the event information received in step 202 and based on the user preference(s) received in step 204, event management engine 108 (see FIG. 1) determines whether or not the event is relevant to user(s) of the social networking service. For example, if the event is a party celebrating Person X's birthday, and User A's activity stream managed by a social networking service includes information about Person X's upcoming birthday, then event management engine 108 (see FIG. 1) determines that the birthday party for Person X is relevant to User A.

In step 208, retail service engine 106 (see FIG. 1) receives retail offer(s) 116 (see FIG. 1). In one embodiment, the retail offer(s) 116 (see FIG. 1) are received in step 208 from one or more users of the social networking service. The one or more users may select an option in an interface provided by the social networking service that automatically forwards retail offers received by the one or more other users to a user or to a group utilizing the social networking service, where the one or more other users indicate that they are not interested in redeeming the retail offers being forwarded. In one embodiment, the retail offer(s) 116 (see FIG. 1) are initially received by the user(s) in message(s) sent by retailer(s) to the user(s) via the social networking service. The retail offers may also be initially received in e-mails or in other forms of communication sent by a retailer to the user(s).

In step 210, using information received in step 204, retail service engine 106 (see FIG. 1) determines which retail offer(s) received in step 208 are relevant to the event, and determines retail service(s) 118 (see FIG. 1) that provide the retail offer(s) that are relevant to the event. In one embodiment, step 210 includes the retail service engine 106 (see FIG. 1) determining one or more retail offers received in step 208 are relevant to an individual associated with the event (e.g., the event is a birthday party and the individual associated with the event is the person whose birthday is being celebrated at the birthday party).

In step 212, based on the event being relevant to the user(s) of the social networking service (as determined in step 206), and based on the retail offer(s) being relevant to the event (as determined in step 210), retail-event object manager 126 (see FIG. 1) generates and initiates a presentation of a display of the retail offer(s) relevant to the event. In one embodiment, computer system 102 (see FIG. 1) or another computer system generates the display of the retail offer(s) in an interface of the social networking service for viewing by the user(s) of the social networking service for whom the event is relevant.

In step 214, retail-event object manager 126 (see FIG. 1) or another component of computer system 102 (see FIG. 1) determines that one or more of the retail offer(s) included in the display generated in step 212 are redeemed by user(s) to whom the event was determined to be relevant in step 206 (e.g., redeemed by a person who is invited to the event). In one embodiment, determining that a user redeemed a retail offer in step 214 includes computer system 102 (see FIG. 1) determining that the user selected a link to the retail offer, where the link was included in the display generated in step 212. Computer system 102 (see FIG. 1) further determines or receives an indication that the user subsequently made selection(s) and/or entry(ies) to redeem the retail offer. In another embodiment, determining that a user redeemed a retail offer in step 214 includes computer system 102 (see FIG. 1) or another computer system receiving a computer interface entry by the user, where the entry indicates the retail offer has been redeemed (e.g., receiving the user's entry of a check in a checkbox associated with the retail offer).

In step 216, based on the determination in step 214 that the one or more retail offers are redeemed, retail-event object manager 126 (see FIG. 1) dynamically updates the display previously generated in step 212. In one embodiment, step 216 includes retail-event object manager 126 (see FIG. 1) updating the display generated in step 212 by adding or modifying graphical element(s) or graphical attribute(s) of the display to indicate the redeemed retail offer(s). For example, retail-event object manager 126 may add a picture of User 1 next to Retail Offer 1 included in the display of retail offers to indicate that User 1 redeemed Retail Offer 1. In another embodiment, retail-event object manager 126 may remove the one or more redeemed retail offers from the display previously generated in step 212.

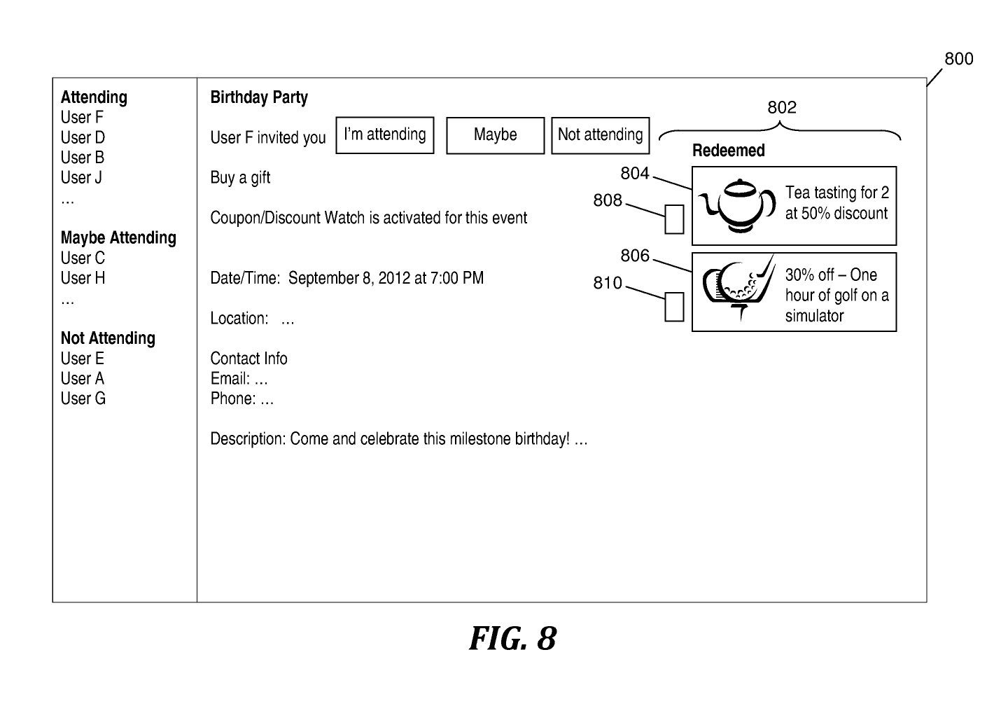

Each user for which the event was determined to be relevant in step 206 may view the indication(s) in the display updated in step 216 to determine what retail offer(s) have been redeemed by other user(s). FIG. 8 includes an example of the display updated in step 216.

Although not shown in FIG. 2, the process may loop back to step 208 to receive other retail offer(s) or back to step 214 to determine that other retail offer(s) have been redeemed.

Following step 216, the process of FIG. 2 ends at step 218.

### Managing Retail Offer(s) Based on a Relationship Provided by a Social Networking Service

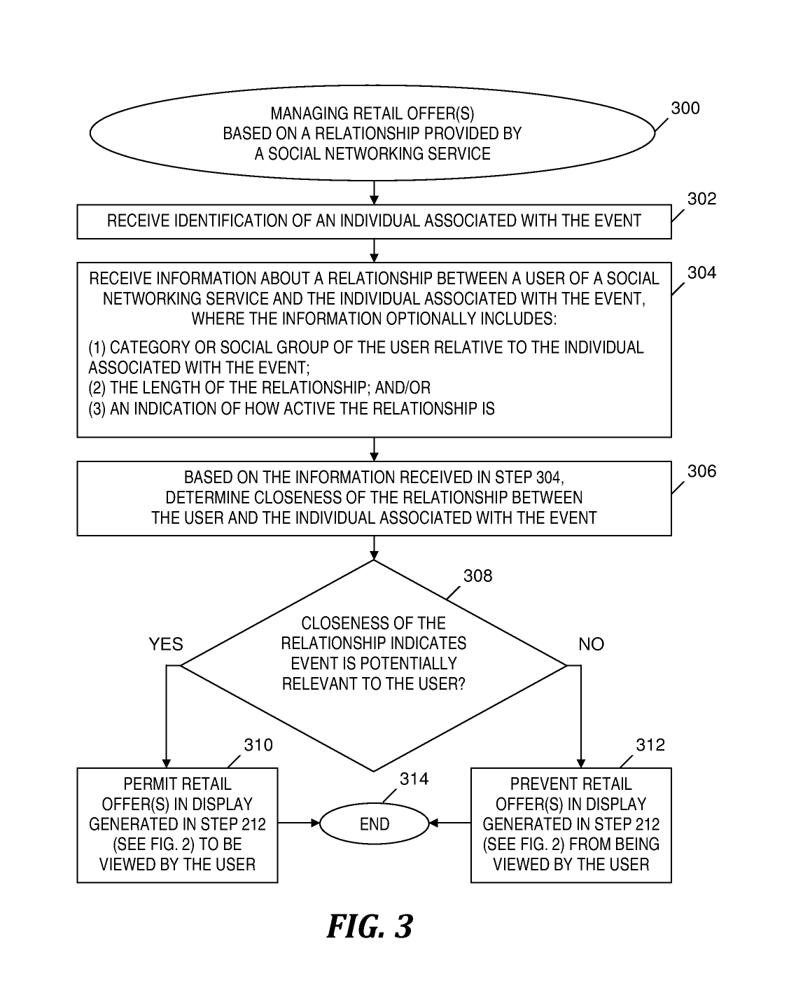

FIG. 3 is a flowchart of a process of managing one or more retail offers based on a relationship provided by a social networking service, where the process is implemented in the system of FIG. 1, in accordance with embodiments of the present invention. The process of FIG. 3 starts at step 300. In step 302, computer system 102 (see FIG. 1) receives an identification of an individual associated with the event (e.g., receives an identification of the person whose birthday is being celebrated).

In step 304, computer system 102 (see FIG. 1) receives information about a relationship between a user of the social networking service and the individual associated with the event (i.e., the individual whose identification was received in step 302). In one embodiment, the information received in step 304 includes (1) an identification of a category or social group of the user, where the category or social group is the same as, included in, or otherwise related to a category or social group of the individual associated with the event; (2) the length of the relationship between the user and the individual associated with the event (i.e., an amount of time indicating how long the relationship has existed); and/or (3) an indication of how active the relationship is between the user and the individual associated with the event.

In step 306, based on the information received in step 304, computer system 102 (see FIG. 1) determines a closeness of the relationship between the user and the individual associated with the event.

In step 308, computer system 102 (see FIG. 1) determines whether the closeness determined in step 306 indicates the event is potentially relevant to the user. If step 308 determines that the closeness indicates the event is potentially relevant to the user, then the Yes branch of step 308 is taken and step 310 is performed. In step 310, computer system 102 (see FIG. 1) permits the retail offer(s) in the display generated in step 212 (see FIG. 2) to be viewed by the user.

Returning to step 308, if computer system 102 (see FIG. 1) determines that the closeness determined in step 306 does not indicate the event is potentially relevant to the user, then the No branch of step 308 if taken and step 312 is performed. In step 312, computer system 102 (see FIG. 1) prevents the retail offer(s) in the display generated in step 212 (see FIG. 2) from being viewed by the user.

Following step 310 and step 312, the process of FIG. 3 ends at step 314.

### Managing a Display of Retail Offers Based on Geographic Proximity

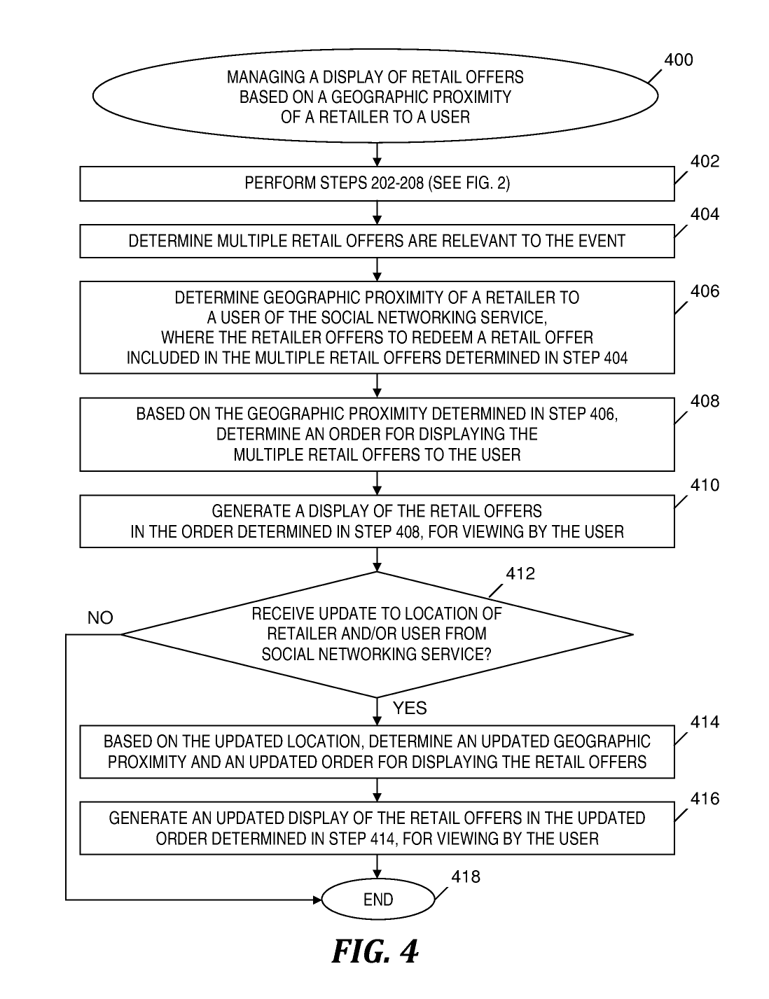

FIG. 4 is a flowchart of a process of managing a display of retail offers based on a geographic proximity of a retailer to a user, where the process is implemented in the system of FIG. 1, in accordance with embodiments of the present invention. The process of FIG. 4 begins at step 400. In step 402, computer system 102 (see FIG. 1) performs steps 202-208 (see FIG. 2).

In step 404, computer system 102 (see FIG. 1) determines multiple retail offers that are relevant to the event, and determines that a retailer offers to redeem a retail offer included in the multiple retail offers. Hereinafter in the discussion of FIG. 4, the aforementioned retailer who offers to redeem the retail offer included in the multiple retail offers is referred to simply as “the retailer.”

In step 406, computer system 102 (see FIG. 1) determines a geographic proximity of the retailer to a user of the social networking service.

In step 408, based at least in part on the geographic proximity determined in step 406, computer system 102 (see FIG. 1) determines an order in which the multiple retail offers are to be displayed to the user of the social networking service.

In step 410, computer system 102 (see FIG. 1) generates a display of the multiple retail offers placed in the order determined in step 408, where the display is for viewing by the user of the social networking service.

In step 412, computer system 102 (see FIG. 1) determines whether computer system 102 (see FIG. 1) receives an updated location from the social networking service, where the updated location is an update to the geographic location of the retailer and/or the geographic location of the user. If step 412 determines that the updated location is received, then the Yes branch of step 412 is taken and step 414 is performed.

In step 414, based on the updated location received in step 412, computer system 102 (see FIG. 1) determines an updated geographic proximity and an updated order for displaying the multiple retail offers.

In step 416, computer system 102 (see FIG. 1) generates an updated display of the multiple retail offers placed in the updated order determined in step 414, where the updated display is for viewing by the user of the social networking service. Following step 416, the process of FIG. 4 ends at step 418.

Returning to step 412, if no updated location is received by computer system 102 (see FIG. 1), then the No branch of step 412 is taken and the process of FIG. 4 ends at step 418.

### Managing a Display of Retail Offers Based on Categories

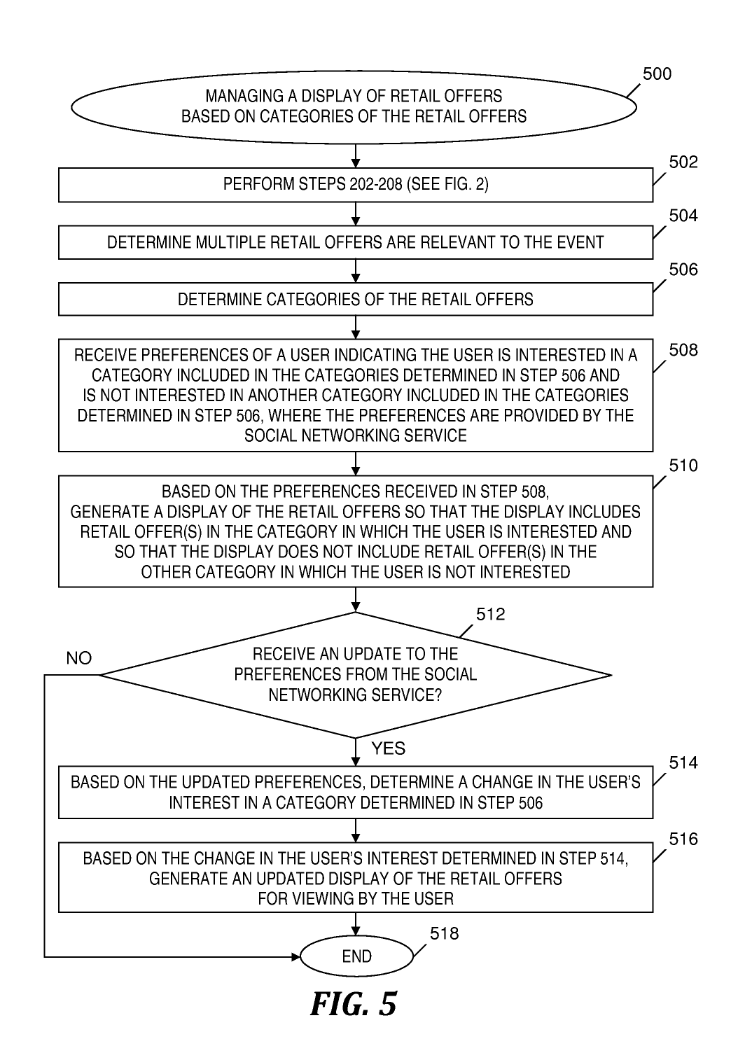

FIG. 5 is a flowchart of a process of managing a display of retail offers based on categories of the retail offers, where the process is implemented in the system of FIG. 1, in accordance with embodiments of the present invention. The process of FIG. 5 starts at step 500. In step 502, computer system 102 (see FIG. 1) performs steps 202-208 (see FIG. 2).

In step 504, computer system 102 (see FIG. 1) determines multiple retail offers are relevant to the event.

In step 506, computer system 102 (see FIG. 1) determines categories of the retail offers determined in step 504. In one embodiment, the categories determined in step 506 specify the types of products or services that can be purchased via the retail offers determined in step 504. For example, the categories determined in step 506 may include books, movies, music, games, clothing, and electronics.

In step 508, computer system 102 (see FIG. 1) receives preferences of a user of the social networking service, where the preferences are stored and provided by the social networking service. In a subsequent part of step 508, computer system 102 (see FIG. 1) determines one category in which the user is interested based on the preferences received in step 508 and another category in which the user is not interested based on the received preferences, where the one category and the other category are included in the categories determined in step 506.

In step 510, based on the preferences received in step 508, computer system 102 (see FIG. 1) generates a display of at least one of the multiple retail offers determined in step 504. The display generated in step 510 includes retail offer(s) in the category in which the user is interested, as determined in step 508, and does not include retail offer(s) included in the other category in which the user is not interested, as determined in step 508.

In step 512, computer system 102 (see FIG. 1) determines whether an update to one or more preferences provided by the social networking service is received by computer system 102 (see FIG. 1). If an update to the one or more preferences is received by computer system 102 (see FIG. 1) in step 512, then the Yes branch of step 512 is taken and step 514 is performed.

In step 514, based on the updated preference(s), computer system 102 (see FIG. 1) determines a change in the user's interest in a category determined in step 506, where the change may be (1) a change from the user being interested in the category to the user being not interested in the category, or (2) a change from the user being not interested in the category to the user being interested in the category.

In step 516, based on the change in the user's interest determined in step 514, computer system 102 (see FIG. 1) generates an updated display of at least one of the multiple retail offers determined in step 504 for viewing by the user. Generating the updated display in step 516 may include removing retail offer(s) in a category that had previously been in the display generated in step 510 if step 514 determined that the user's interest changed from having an interest in the category to not having an interest in the category. Generating the updated display may include adding retail offer(s) in a category that had previously not been in the display generated in step 510 if step 514 determined that the user's interest changed from not having an interest in the category to having an interest in the category.

Following step 516, the process of FIG. 5 ends at step 518.

Returning to step 512, if computer system 102 (see FIG. 1) determines that an update to the preferences provided by the social networking service is not received, then the No branch of step 512 is taken and the process of FIG. 5 ends at step 518.

### Managing a Display of Retail Offers Based on an Attribute of the Retail Offers

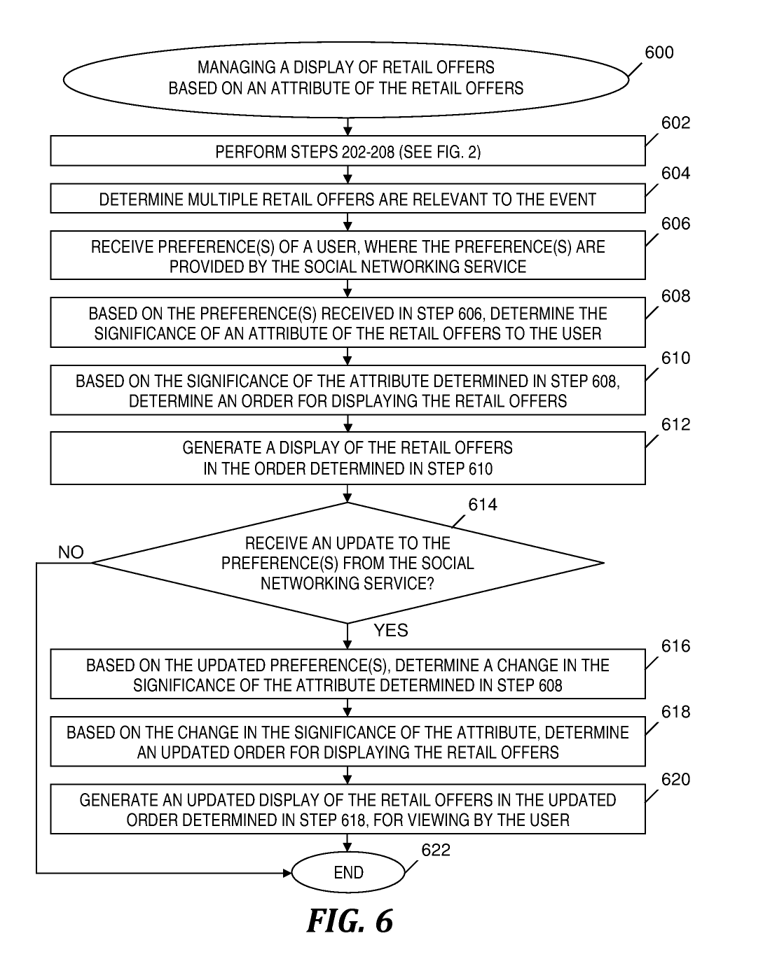

FIG. 6 is a flowchart of a process of managing a display of retail offers based on an attribute of the retail offers, where the process is implemented in the system of FIG. 1, in accordance with embodiments of the present invention. The process of FIG. 6 starts at step 600. In step 602, computer system 102 (see FIG. 1) performs steps 202-208 (see FIG. 2).

In step 604, computer system 102 (see FIG. 1) determines multiple retail offers are relevant to the event and determines an attribute of the multiple retail offers. For example, the attribute may be the cost of each retail offer or a brand name associated with each retail offer.

In step 606, computer system 102 (see FIG. 1) receives preferences of a user of the social networking service, where the preferences are stored and provided by the social networking service.

In step 608, based on the preferences received in step 606, computer system 102 (see FIG. 1) determines a significance of the attribute determined in step 604 (i.e., a significance that the user attaches to the attribute).

In step 610, based on the significance of the attribute determined in step 608, computer system 102 (see FIG. 1) determines an order for displaying the multiple retail offers determined in step 604 (i.e., an order in which the multiple retail offers are placed in a display).

In step 612, computer system 102 (see FIG. 1) generates a display of the multiple retail offers determined in step 604, so that the multiple retail offers are arranged in the display in the order determined in step 610.

In step 614, computer system 102 (see FIG. 1) determines whether an update to one or more preferences provided by the social networking service is received by computer system 102 (see FIG. 1). If an update to the one or more preferences is received by computer system 102 (see FIG. 1) in step 614, then the Yes branch of step 614 is taken and step 616 is performed.

In step 616, based on the updated preference(s), computer system 102 (see FIG. 1) determines a change in the significance of the attribute determined in step 608.

In step 618, based on the change in the significance of the attribute determined in step 616, computer system 102 (see FIG. 1) determines an updated order for displaying the multiple retail offers.

In step 620, computer system 102 (see FIG. 1) generates an updated display of the multiple retail offers arranged in the updated order determined in step 618, for viewing by the user. For example, generating the updated display in step 620 may include re-ordering the retail offers so that a retail offer for an item of brand XYZ is moved to a first position in the re-ordered retail offers because having the brand XYZ is an attribute whose significance to the user was increased to the highest significance.

Following step 620, the process of FIG. 6 ends at step 622.

Returning to step 614, if computer system 102 (see FIG. 1) determines that an update to the preferences provided by the social networking service is not received, then the No branch of step 614 is taken and the process of FIG. 6 ends at step 622.

Managing Retail Offers Based on a Time Period Associated with an Event

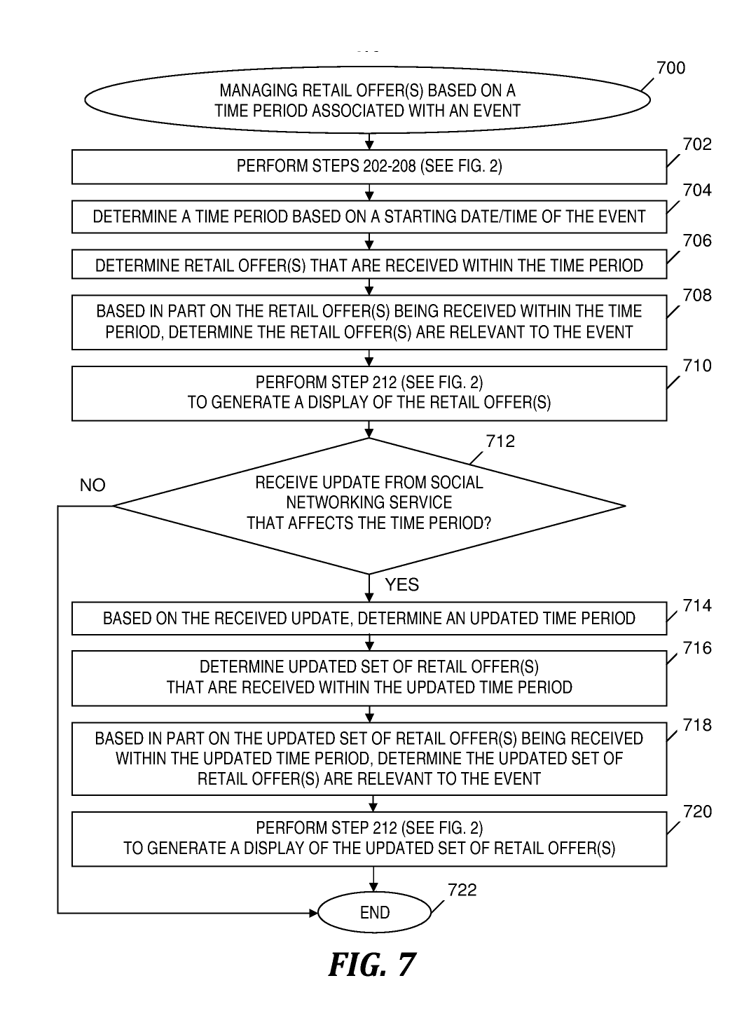

FIG. 7 is a flowchart of a process of managing one or more retail offers based on a time period associated with an event, where the process is implemented in the system of FIG. 1, in accordance with embodiments of the present invention. The process of FIG. 7 starts at step 700. In step 702, computer system 102 (see FIG. 1) performs steps 202-208 (see FIG. 2).

In step 704, computer system 102 (see FIG. 1) determines a time period based on a starting date and optionally based on a starting time of the event.

In step 706, computer system 102 (see FIG. 1) receives retail offers and determines the retail offer(s) that are received within the time period determined in step 704.

In step 708, based in part on the retail offer(s) being received within the time period determined in step 704, computer system 102 (see FIG. 1) determines that the retail offer(s) are relevant to the event.

In an alternate embodiment, step 706 includes computer system 102 (see FIG. 1) receiving retail offers, determining a time period during which each received retail offer is allowed to be redeemed, and determining which retail offers are redeemable within the time period determined in step 704. In this alternate embodiment, step 708 includes computer system 102 (see FIG. 1) determining the retail offer(s) that are relevant to the event based in part on the retail offer(s) being redeemable during the time period determined in step 704.

In step 710, computer system 102 (see FIG. 1) performs step 212 (see FIG. 2) to generate a display of the retail offer(s) determined to be relevant to the event in step 708.

In step 712, computer system 102 (see FIG. 1) determines whether an update affecting the time period determined in step 704 is received from the social networking service. If an update to the time period determined in step 704 is received in step 712, then the Yes branch of step 712 is taken and step 714 is performed.

In step 714, based on the received update, computer system 102 (see FIG. 1) determines an updated time period (i.e., an updated version of the time period previously determined in step 704).

In step 716, computer system 102 (see FIG. 1) determines an updated set of retail offer(s) that are received within the updated time period. In an alternate embodiment, step 716 includes computer system 102 (see FIG. 1) determining an updated set of retail offer(s) that are redeemable during the updated time period.

In step 718, based in part on the updated set of retail offer(s) being received within the updated time period, computer system 102 (see FIG. 1) determines the updated set of retail offer(s) are relevant to the event. In an alternate embodiment, in step 718, based in part on the updated set of retail offer(s) being redeemable within the updated time period, computer system 102 (see FIG. 1) determines the updated set of retail offer(s) are relevant to the event.

In step 720, computer system 102 (see FIG. 1) performs step 212 (see FIG. 2) to generate a display of the updated set of retail offer(s). Following step 720, the process of FIG. 7 ends at step 722.

Returning to step 712, if computer system 102 (see FIG. 1) determines that an update that affects the time period previously determined in step 704 is not received, then the No branch of step 712 is taken and the process of FIG. 7 ends at step 722.

### Example

FIG. 8 is an exemplary view of an event page provided by a social networking service, where the event page includes information about an event and a dynamically updated list of retail offers managed by the process of FIG. 2, in accordance with embodiments of the present invention.

View 800 is a sample screenshot of an event page for a birthday party, where the event page is provided by a social networking service. View 800 includes the following information about the birthday party: (1) starting date and starting time of the birthday party; (2) location of the birthday party; (3) contact information for a person who invited the user who is viewing view 800; (4) a description of the birthday party; and (5) the name of the person who invited the user to the birthday party.

View 800 also includes a notification that a “Coupon/Discount Watch” is activated for the birthday party. Because the Coupon/Discount Watch is activated, the process of FIG. 2 collects retail offers relevant to the birthday party and displays the relevant retail offers in an area 802 in the rightmost column of view 800. Area 802 includes a sample list of two retail offers 804 and 806 that were determined to be relevant to the birthday party and have been redeemed. Area 802 also includes pictures of a first user 808 and a second user 810 who redeemed retail offers 804 and 806, respectively. The list of redeemed retail offers in area 802 may be displayed in view 800 as a result of step 216 (see FIG. 2).

In the leftmost column, view 800 includes a list of names of users who are planning to attend the birthday party, users who indicated that they may be attending the birthday party, and users who have indicated that they are not planning to attend the birthday party.

View 800 also includes three graphical elements (i.e., buttons) labeled “I'm attending,” “Maybe” and “Not attending,” which may be selected by the user who is viewing view 800 to indicate that the user (1) is planning to attend the birthday party, (2) may attend the birthday party, or (3) is not planning to attend the birthday party.

### Computer System

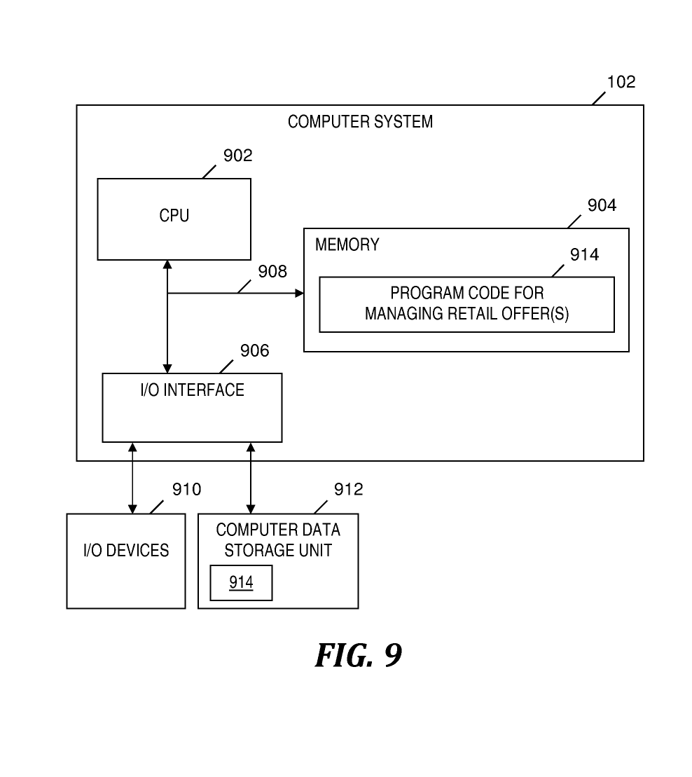

FIG. 9 is a block diagram of a computer system that is included in the system of FIG. 1 and that implements the processes of FIG. 2, FIG. 3, FIG. 4, FIG. 5, FIG. 6 and FIG. 7 in accordance with embodiments of the present invention. Computer system 102 generally includes a central processing unit (CPU) 902, a memory 904, an input/output (I/O) interface 906, and a bus 908. Further, computer system 102 is coupled to I/O devices 910 and a computer data storage unit 912. CPU 902 performs computation and control functions of computer system 102, including carrying out instructions included in program code 914 to perform a method of managing one or more retail offers, where the instructions are carried out by CPU 902 via memory 904. CPU 902 may include a single processing unit, or be distributed across one or more processing units in one or more locations (e.g., on a client and server). In one embodiment, program code 914 includes code for social network influence engine 104 (see FIG. 1), retail service engine 106 (see FIG. 1), event management engine 108 (see FIG. 1), timing analysis tool 120, qualitative analysis tool 124, and retail-event object manager 126 (see FIG. 1).

Memory 904 may include any known computer-readable storage medium, which is described below. In one embodiment, cache memory elements of memory 904 provide temporary storage of at least some program code (e.g., program code 914) in order to reduce the number of times code must be retrieved from bulk storage while instructions of the program code are carried out. Moreover, similar to CPU 902, memory 904 may reside at a single physical location, including one or more types of data storage, or be distributed across a plurality of physical systems in various forms. Further, memory 904 can include data distributed across, for example, a local area network (LAN) or a wide area network (WAN).

I/O interface 906 includes any system for exchanging information to or from an external source. I/O devices 910 include any known type of external device, including a display device (e.g., monitor), keyboard, mouse, printer, speakers, handheld device, facsimile, etc. Bus 908 provides a communication link between each of the components in computer system 102, and may include any type of transmission link, including electrical, optical, wireless, etc.

I/O interface 906 also allows computer system 102 to store information (e.g., data or program instructions such as program code 914) on and retrieve the information from computer data storage unit 912 or another computer data storage unit (not shown). Computer data storage unit 912 may include any known computer-readable storage medium, which is described below. For example, computer data storage unit 912 may be a non-volatile data storage device, such as a magnetic disk drive (i.e., hard disk drive) or an optical disc drive (e.g., a CD-ROM drive which receives a CD-ROM disk).

Memory 904 and/or storage unit 912 may store computer program code 914 that includes instructions that are carried out by CPU 902 via memory 904 to manage one or more retail offers. Although FIG. 9 depicts memory 904 as including program code 914, the present invention contemplates embodiments in which memory 904 does not include all of code 914 simultaneously, but instead at one time includes only a portion of code 914.

Further, memory 904 may include other systems not shown in FIG. 9, such as an operating system (e.g., Linux®) that runs on CPU 902 and provides control of various components within and/or connected to computer system 102. Linux is a registered trademark of Linus Torvalds in the United States, other countries, or both.

Storage unit 912 and/or one or more other computer data storage units (not shown) that are coupled to computer system 102 may store real-time update(s) 110 (see FIG. 1), retail offer(s) 116 (see FIG. 1), retail service(s) 118 (see FIG. 1), event(s) of interest 114 (see FIG. 1) and/or retail-event object 122 (see FIG. 1).

As will be appreciated by one skilled in the art, in a first embodiment, the present invention may be a system; in a second embodiment, the present invention may be a method; and in a third embodiment, the present invention may be a computer program product. A component of an embodiment of the present invention may take the form of an entirely hardware-based component, an entirely software component (including firmware, resident software, micro-code, etc.) or a component combining software and hardware sub-components that may all generally be referred to herein as a “module”.

An embodiment of the present invention may take the form of a computer program product embodied in one or more computer-readable medium(s) (e.g., memory 904 and/or computer data storage unit 912) having computer-readable program code (e.g., program code 914) embodied or stored thereon.

Any combination of one or more computer-readable mediums (e.g., memory 904 and computer data storage unit 912) may be utilized. The computer readable medium may be (1) a computer-readable storage medium or (2) a computer-readable signal medium. As used herein, a computer-readable storage medium is not a computer-readable signal medium.

In one embodiment, the computer-readable storage medium is a physical, tangible computer-readable storage device or physical, tangible computer-readable storage apparatus that stores but does not propagate. A computer-readable storage medium may include, for example, an electronic, magnetic, optical, electromagnetic, or semiconductor system, apparatus, device or any suitable combination of the foregoing. A non-exhaustive list of more specific examples of the computer-readable storage medium includes: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium is a physical, tangible storage medium that can contain or store a program (e.g., program 914) for use by or in connection with a system, apparatus, or device for carrying out instructions in the program, and which does not propagate.

A computer-readable signal medium may include a propagated data signal with computer-readable program code embodied therein, for example, in baseband or as part of a carrier wave. Such a propagated signal may take any of a variety of forms, including, but not limited to, electromagnetic, optical, or any suitable combination thereof. A computer-readable signal medium may be any computer-readable medium that is not a computer-readable storage medium and that can communicate, propagate, or transport a program for use by or in connection with a system, apparatus, or device for carrying out instructions.

Program code (e.g., program code 914) embodied on a computer-readable medium may be transmitted using any appropriate medium, including but not limited to wireless, wireline, optical fiber cable, radio frequency (RF), etc., or any suitable combination of the foregoing.

Computer program code (e.g., program code 914) for carrying out operations for aspects of the present invention may be written in any combination of one or more programming languages, including an object oriented programming language such as Java®, Smalltalk, C++ or the like and conventional procedural programming languages, such as the “C” programming language or similar programming languages. Java and all Java-based trademarks and logos are trademarks or registered trademarks of Oracle and/or its affiliates. Instructions of the program code may be carried out entirely on a user's computer, partly on the user's computer, as a stand-alone software package, partly on the user's computer and partly on a remote computer or entirely on the remote computer or server, where the aforementioned user's computer, remote computer and server may be, for example, computer system 102 or another computer system (not shown) having components analogous to the components of computer system 102 included in FIG. 9. In the latter scenario, the remote computer may be connected to the user's computer through any type of network (not shown), including a LAN or a WAN, or the connection may be made to an external computer (e.g., through the Internet using an Internet Service Provider).

Aspects of the present invention are described herein with reference to flowchart illustrations (e.g., FIG. 2, FIG. 3, FIG. 4, FIG. 5, FIG. 6 and FIG. 7) and/or block diagrams of methods, apparatus (systems) (e.g., FIG. 1 and FIG. 9), and computer program products according to embodiments of the invention. It will be understood that each block of the flowchart illustrations and/or block diagrams, and combinations of blocks in the flowchart illustrations and/or block diagrams, can be implemented by computer program instructions (e.g., program code 914). These computer program instructions may be provided to one or more hardware processors (e.g., CPU 902) of a general purpose computer, special purpose computer, or other programmable data processing apparatus to produce a machine, such that the instructions, which are carried out via the processor(s) of the computer or other programmable data processing apparatus, create means for implementing the functions/acts specified in the flowcharts and/or block diagram block or blocks.

These computer program instructions may also be stored in a computer-readable medium (e.g., memory 904 or computer data storage unit 912) that can direct a computer (e.g., computer system 102), other programmable data processing apparatus, or other devices to function in a particular manner, such that the instructions (e.g., program 914) stored in the computer-readable medium produce an article of manufacture including instructions which implement the function/act specified in the flowcharts and/or block diagram block or blocks.

The computer program instructions may also be loaded onto a computer (e.g., computer system 102), other programmable data processing apparatus, or other devices to cause a series of operational steps to be performed on the computer, other programmable apparatus, or other devices to produce a computer implemented process such that the instructions (e.g., program 914) which are carried out on the computer, other programmable apparatus, or other devices provide processes for implementing the functions/acts specified in the flowcharts and/or block diagram block or blocks.

Any of the components of an embodiment of the present invention can be deployed, managed, serviced, etc. by a service provider that offers to deploy or integrate computing infrastructure with respect to managing one or more retail offers. Thus, an embodiment of the present invention discloses a process for supporting computer infrastructure, wherein the process includes providing at least one support service for at least one of integrating, hosting, maintaining and deploying computer-readable code (e.g., program code 914) in a computer system (e.g., computer system 102) including one or more processors (e.g., CPU 902), wherein the processor(s) carry out instructions contained in the code causing the computer system to manage one or more retail offers.

While it is understood that program code 914 for managing retail offer(s) may be deployed by manually loading directly in client, server and proxy computers (not shown) via loading a computer-readable storage medium (e.g., computer data storage unit 912), program code 914 may also be automatically or semi-automatically deployed into computer system 102 by sending program code 914 to a central server (e.g., computer system 102) or a group of central servers. Program code 914 is then downloaded into client computers (not shown) that will execute program code 914. Alternatively, program code 914 is sent directly to the client computer via e-mail. Program code 914 is then either detached to a directory on the client computer or loaded into a directory on the client computer by a button on the e-mail that executes a program that detaches program code 914 into a directory. Another alternative is to send program code 914 directly to a directory on the client computer hard drive. In a case in which there are proxy servers, the process selects the proxy server code, determines on which computers to place the proxy servers' code, transmits the proxy server code, and then installs the proxy server code on the proxy computer. Program code 914 is transmitted to the proxy server and then it is stored on the proxy server.

In one embodiment, program code 914 for managing retail offer(s), which consists of (1) code for managing retail offer(s) based on a relationship provided by a social networking service; (2) code for managing a display of retail offers based on a geographic proximity of a retailer to a user; (3) code for managing a display of retail offers based on categories of the retail offers; (4) code for managing a display of retail offers based on an attribute of the retail offers; and (5) code for managing retail offer(s) based on a time period associated with an event, is integrated into a client, server and network environment by providing for program code 914 to coexist with software applications (not shown), operating systems (not shown) and network operating systems software (not shown) and then installing program code 914 on the clients and servers in the environment where program code 914 will function.

The first step of the aforementioned integration of code included in program code 914 is to identify any software on the clients and servers including the network operating system (not shown) where program code 914 will be deployed that are required by program code 914 or that work in conjunction with program code 914. This identified software includes the network operating system that is software that enhances a basic operating system by adding networking features. Next, the software applications and version numbers are identified and compared to the list of software applications and version numbers that have been tested to work with program code 914. Those software applications that are missing or that do not match the correct version are upgraded with the correct version numbers. Program instructions that pass parameters from program code 914 to the software applications are checked to ensure the parameter lists match the parameter lists required by the program code 914. Conversely, parameters passed by the software applications to program code 914 are checked to ensure the parameters match the parameters required by program code 914. The client and server operating systems including the network operating systems are identified and compared to the list of operating systems, version numbers and network software that have been tested to work with program code 914. Those operating systems, version numbers and network software that do not match the list of tested operating systems and version numbers are upgraded on the clients and servers to the required level. After ensuring that the software, where program code 914 is to be deployed, is at the correct version level that has been tested to work with program code 914, the integration is completed by installing program code 914 on the clients and servers.

Another embodiment of the invention provides a method that performs the process steps on a subscription, advertising and/or fee basis. That is, a service provider, such as a Solution Integrator, can offer to create, maintain, support, etc. a process of managing one or more retail offers. In this case, the service provider can create, maintain, support, etc. a computer infrastructure that performs the process steps for one or more customers. In return, the service provider can receive payment from the customer(s) under a subscription and/or fee agreement, and/or the service provider can receive payment from the sale of advertising content to one or more third parties.

The flowcharts in FIG. 2, FIG. 3, FIG. 4, FIG. 5, FIG. 6 and FIG. 7 and the block diagrams in FIG. 1 and FIG. 9 illustrate the architecture, functionality, and operation of possible implementations of systems, methods, and computer program products according to various embodiments of the present invention. In this regard, each block in the flowcharts or block diagrams may represent a module, segment, or portion of code (e.g., program code 914), which includes one or more executable instructions for implementing the specified logical function(s). It should also be noted that, in some alternative implementations, the functions noted in the block may occur out of the order noted in the figures. For example, two blocks shown in succession may, in fact, be performed substantially concurrently, or the blocks may sometimes be performed in reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method of managing one or more retail offers, the method comprising the steps of:
a computer receiving information about an event;
the computer determining the event is relevant to one or more users of a social network web site by:
determining preferences of the one or more users, the preferences saved via the social network web site; and
determining the one or more users have an interest in the event based on the preferences;
the computer receiving a plurality of retail offers;
the computer determining one or more retail offers included in the plurality of retail offers are relevant to the event by:
determining at least one preference of an individual associated with the event, the at least one preference saved via the social network website; and
determining the individual has an interest in the one or more retail offers based on the at least one preference; and
based on the event being relevant to the one or more users and based on the one or more retail offers being relevant to the event, the computer initiating a display of the one or more retail offers for viewing by the one or more users via an interface provided by the social network website.

2. The method of claim 1, further comprising:
the computer determining a closeness of a relationship between the individual associated with the event and a user of the social network website; and
based on the closeness of the relationship between the individual associated with the event and the user of the social network website, and based on the one or more retail offers being relevant to the event, the computer initiating a display of the one or more retail offers for viewing by the user via the interface provided by the social network website.

3. The method of claim 1, further comprising the steps of:
the computer determining the plurality of retail offers is relevant to the event;
the computer determining a proximity of a geographic location of a retailer to a geographic location of a user of the social network website, the retailer offering a retail offer included in the plurality of retail offers, and the user included in the one or more users to whom the event is relevant;
based on the proximity, the computer determining a placement of the retail offer among other retail offer(s) included in the plurality of retail offers; and
the computer initiating a display of the plurality of retail offers for viewing by the user, the display including the plurality of retail offers in an order based on the placement.

4. The method of claim 1, further comprising the steps of:
the computer determining a user redeemed a retail offer, the user included in the one or more users, and the retail offer included in the one or more retail offers; and
in response to the step of determining the user redeemed the retail offer, the computer updating the display of the one or more retail offers by adding to the display an indication that the retail offer was redeemed.

5. The method of claim 4, wherein the step of the computer updating the display of the one or more retail offers includes the computer adding to the display a first identification of the user who redeemed the retail offer, a second identification of a group to which the user belongs, or a combination of the first and second identifications.

6. The method of claim 4, wherein the step of the computer updating the display of the one or more retail offers includes adding to the display a hyperlink to a profile of the user, the profile provided by the social network website.

7. The method of claim 1, further comprising the steps of:
the computer determining the plurality of retail offers is relevant to the event;
the computer determining categories of the retail offers;
the computer determining a preference of a user of the social network website, the preference indicating a category included in the categories of the retail offers, and the preference saved by the social network website; and
the computer initiating a display of the plurality of retail offers for viewing by the user, the display based on the category indicated by the preference of the user.

8. The method of claim 1, further comprising the steps of:
the computer determining the plurality of retail offers is relevant to the event;
the computer receiving preferences saved by the social network website, the received preferences being preferences of the individual associated with the event or preferences of the one or more users, and the received preferences indicating a prioritization of the plurality of retail offers according to at least one attribute of the plurality of retail offers; and
the computer presenting a display of the plurality of retail offers in an order based on the prioritization indicated by the received preferences.

9. The method of claim 8, further comprising the steps of:
the computer adding to the display a plurality of hyperlinks to retailers offering the plurality of retail offers;
the computer receiving an update of a preference included in the received preferences;
based on the received update of the preference, the computer updating the display of the plurality of retail offers by removing a hyperlink included in the plurality of hyperlinks or adding a hyperlink to another retailer.

10. The method of claim 1, further comprising the steps of:
the computer receiving an activity stream of a user, the activity stream provided by the social network website, and the user included in the one or more users;
the computer obtaining preferences of the user from the activity stream; and
the computer determining the event is relevant to the user based on the preferences obtained from the activity stream.

11. The method of claim 1, further comprising the steps of:
the computer determining the plurality of retail offers is relevant to the event;
the computer determining a first category so that each retail offer of the plurality of retail offers included in the first category is redeemed, the first category indicating a first type of a product or a first type of a service;
the computer determining a second category so that each retail offer of the plurality of retail offers included in the second category is not redeemed, the second category indicating a second type of a product or a second type of a service; and
the computer initiating a display of the plurality of retail offers grouped at least by the first and second categories, the display including a first indication that each retail offer in the first category is redeemed, and the display further including a second indication that each retail offer in the second category is not redeemed.

12. The method of claim 1, further comprising the steps of:
subsequent to the step of initiating the display of the one or more retail offers, the computer receiving an indication of a change in a relevancy of a retail offer to the event, the change indicating the retail offer has changed from being relevant to the event to being not relevant to the event, or from being not relevant to the event to being relevant to the event; and
based on the received indication of the change in the relevancy, the computer updating the display of the one or more retail offers.

13. The method of claim 1, further comprising the step of the computer determining the individual associated with the event purchased an item offered by a retail offer included in the one or more retail offers, wherein the step of initiating the display of the one or more retail offers includes presenting an indication of a conflict between the retail offer included in the display and the item purchased by the individual.

14. The method of claim 1, further comprising the steps of:
the computer receiving a specification of a time period based on a starting time of the event; and
the computer determining the one or more retail offers are received by the computer within the time period, wherein the step of determining the one or more retail offers are relevant to the event is based on the one or more retail offers being received by the computer within the time period.

15. A computer program product, comprising:
a computer-readable, tangible storage device; and
a computer-readable program code stored in the computer-readable, tangible storage device, the computer-readable program code containing instructions that are carried out by a central processing unit (CPU) of a computer system to implement a method of managing one or more retail offers, the method comprising the steps of:
the computer system receiving information about an event;
the computer system determining the event is relevant to one or more users of a social network website by:
determining preferences of the one or more users, the preferences saved via the social network website; and
determining the one or more users have an interest in the event based on the preferences;
the computer system receiving a plurality of retail offers;
the computer system determining one or more retail offers included in the plurality of retail offers are relevant to the event by:
determining at least one preference of an individual associated with the event, the at least one preference saved via the social network website; and
determining the individual has an interest in the one or more retail offers based on the at least one preference; and
based on the event being relevant to the one or more users and based on the one or more retail offers being relevant to the event, the computer system initiating a display of the one or more retail offers for viewing by the one or more users via an interface provided by the social network website.

16. The program product of claim 15, wherein the method further comprises the steps of:
the computer system determining a closeness of a relationship between the individual associated with the event and a user of the social network website; and
based on the closeness of the relationship between the individual associated with the event and the user of the social network website, and based on the one or more retail offers being relevant to the event, the computer system initiating a display of the one or more retail offers for viewing by the user via the interface provided by the social network website.

17. The program product of claim 15, wherein the method further comprises the steps of:
the computer system determining the plurality of retail offers is relevant to the event;
the computer system determining a proximity of a geographic location of a retailer to a geographic location of a user of the social network website, the retailer offering a retail offer included in the plurality of retail offers, and the user included in the one or more users to whom the event is relevant;
based on the proximity, the computer system determining a placement of the retail offer among other retail offer(s) included in the plurality of retail offers; and
the computer system initiating a display of the plurality of retail offers for viewing by the user, the display including the plurality of retail offers in an order based on the placement.

18. A process for supporting computing infrastructure, the process comprising:
providing at least one support service for at least one of creating, integrating, hosting, maintaining, and deploying computer-readable code in a computer system comprising a processor, wherein the processor carries out instructions contained in the code causing the computer system to perform a method of managing one or more retail offers, the method comprising the steps of:
the computer system receiving information about an event;
the computer system determining the event is relevant to one or more users of a social network website by:
determining preferences of the one or more users, the preferences saved via the social network website; and
determining the one or more users have an interest in the event based on the preferences;
the computer system receiving a plurality of retail offers;
the computer system determining one or more retail offers included in the plurality of retail offers are relevant to the event by:
determining at least one preference of an individual associated with the event, the at least one preference saved via the social network website; and
determining the individual has an interest in the one or more retail offers based on the at least one preference; and
based on the event being relevant to the one or more users and based on the one or more retail offers being relevant to the event, the computer system initiating a display of the one or more retail offers for viewing by the one or more users via an interface provided by the social network website.

19. The process of claim 18, wherein the method further comprises the steps of:
the computer system determining a closeness of a relationship between the individual associated with the event and a user of the social network website; and
based on the closeness of the relationship between the individual associated with the event and the user of the social network website, and based on the one or more retail offers being relevant to the event, the computer system initiating a display of the one or more retail offers for viewing by the user via the interface provided by the social network website.

20. The process of claim 18, wherein the method further comprises:
the computer system determining the plurality of retail offers is relevant to the event;
the computer system determining a proximity of a geographic location of a retailer to a geographic location of a user of the social network website, the retailer offering a retail offer included in the plurality of retail offers, and the user included in the one or more users to whom the event is relevant;
based on the proximity, the computer system determining a placement of the retail offer among other retail offer(s) included in the plurality of retail offers; and
the computer system initiating a display of the plurality of retail offers for viewing by the user, the display including the plurality of retail offers in an order based on the placement.
